(19) United States
(12) Patent Application Publication
(10) Pub. No.: US 2025/0273978 A1
(43) Pub. Date: Aug. 28, 2025

(54) POWER CONTROL METHOD AND RELATED ELECTRONIC DEVICE

(71) Applicant: QISDA CORPORATION, Taoyuan City (TW)

(72) Inventor: Chih-Ming Chang, Taoyuan City (TW)

(73) Assignee: QISDA CORPORATION, Taoyuan City (TW)

(21) Appl. No.: 19/014,261

(22) Filed: Jan. 9, 2025

(30) Foreign Application Priority Data
Feb. 22, 2024 (CN) 202410197138.9

(51) Int. Cl. H02J 7/00

(52) U.S. Cl. CPC H02J 7/00712; H02J 7/0049; H02J 7/0063; H02J 7/007194

(57) ABSTRACT

A power control method is applied to an electronic device with a controller and at least one charger slot. The at least one charger slot is electrically connected to an external battery. The power control method includes analyzing storage capacity and a previous usage point of time of the external battery through the at least one charger slot, and executing a discharger procedure of the external battery to reduce the storage capacity when determining a period length between the previous usage point of time and a current point of time conforms to a first predefined time condition.

### BACKGROUND OF THE INVENTION

### 1. Field of the Invention

The present invention relates to a power control method and a related electronic device, and more particularly, to a power control method and a related electronic device of increasing a battery life and providing preferred operation performance.

### 2. Description of the Prior Art

A conventional charger usually has one charging slot, which is used to charge one external battery at a time; other chargers are equipped with multiple charging slots, and the multiple charging slots are used to charge a plurality of external batteries at the same time, which requires a lot of time to charge the plurality of external batteries at the same time, and the external battery with highest storage capacity does not have charging priority. In addition, the conventional charger only has a charging function, and cannot determine whether the external battery inserted into the charging slot has been idle for too long, or cannot apply a charging function and a discharging function for the external battery that has been idle for too long to control its power within an ideal range; thus, if the external battery is placed in the charging slot for a long while, the external battery is age and has low performance due to self-discharge. Design of a charger and a related power control method of keeping the external battery at optimal operation performance is an important issue in the battery equipment industry.

### SUMMARY OF THE INVENTION

The present invention provides a power control method and a related electronic device of increasing a battery life and providing preferred operation performance for solving above drawbacks.

According to the claimed invention, the power control method is applied to an electronic device having a controller and at least one charger slot. The at least one charger slot is electrically connected with an external battery. The power control method includes analyzing storage capacity and a previous usage point of time of the external battery through the at least one charger slot, and applying a discharger procedure for the external battery to reduce the storage capacity when determining a period length between the previous usage point of time and a current point of time conforms to a first predefined time condition. he power control method further includes terminating the discharger procedure when determining the storage capacity conforms to a first predefined capacity condition.

According to the claimed invention, the electronic device further has a storage component. The power control method further includes utilizing the discharger procedure of the external battery to apply a charger procedure for the storage component. The power control method further includes utilizing the storage component to apply the charger procedure for the external battery when determining the storage capacity conforms to a second predefined capacity condition. The power control method further includes utilizing a detection resistor to apply the discharger procedure for the external battery when the storage component has full power.

According to the claimed invention, the electronic device further has a temperature sensor and a heater. The power control method further includes driving the heater to increase a temperature of the external battery when an ambient temperature acquired by the temperature sensor conforms to a predefined temperature condition. The power control method further includes utilizing the storage component to drive the heater. The power control method further includes applying the discharger procedure for the storage component when the ambient temperature does not conform to the predefined temperature condition and a continuous period of the external battery not executing the charger procedure conforms to a second predefined time condition. The power control method further includes utilizing a detection resistor to apply the discharger procedure for the storage component, or utilizing the discharger procedure to drive the heater.

According to the claimed invention, the electronic device further has a storage component and a plurality of external batteries. The power control method further includes utilizing the storage component to apply a charger procedure for one external battery with highest storage capacity among the plurality of external batteries, and then apply the charger procedure for other external batteries among the plurality of external batteries.

According to the claimed invention, an electronic device with a power control function includes at least one charger slot and a controller. The at least one charger slot is adapted to electrically connect with an external battery. The controller is communicated with the at least one charger slot. The controller is adapted to analyze storage capacity and a previous usage point of time of the external battery through the at least one charger slot, and apply a discharger procedure for the external battery to reduce the storage capacity when determining a period length between the previous usage point of time and a current point of time conforms to a first predefined time condition.

The electronic device of the present invention can be the multiple channel charger, and can be preferably applied for a drone device; therefore, when an emergency flight mission occurs, the electronic device and the power control method of the present invention can give priority to apply the charger procedure for the external battery with the highest storage capacity, and then apply the charger procedure for the external battery with the lower storage capacity, and finally apply the charger procedure for the storage component of the electronic device, so that the external battery can be quickly charged for being installed on the drone device to execute the emergency flight mission. In addition, the electronic device of the present invention can utilize the power control method to switch the charger procedure and the discharger procedure of the external battery and the storage component when the electronic device is idle for a long time, so as to constrain the storage capacity within a predefine range of the capacity condition, and further to adjust the temperature of the electronic device and the external battery via the temperature sensor and the heater, for increasing a product service life and providing the preferred operation performance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an appearance diagram of an electronic device according to an embodiment of the present invention.

FIG. 2 is a functional block diagram of the electronic device according to the embodiment of the present invention.

FIG. 3 is a flow chart of the power control method according to the embodiment of the present invention.

### DETAILED DESCRIPTION

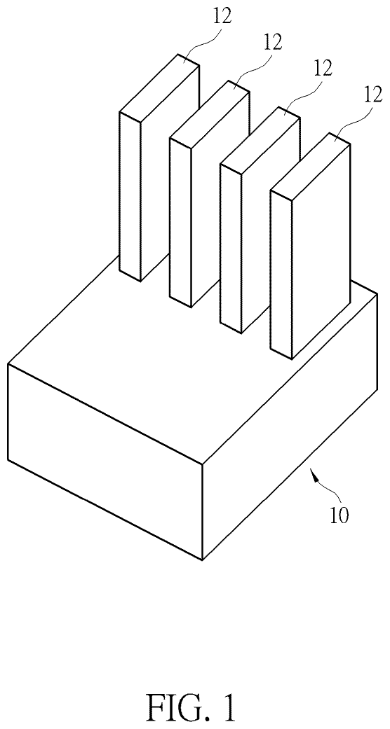

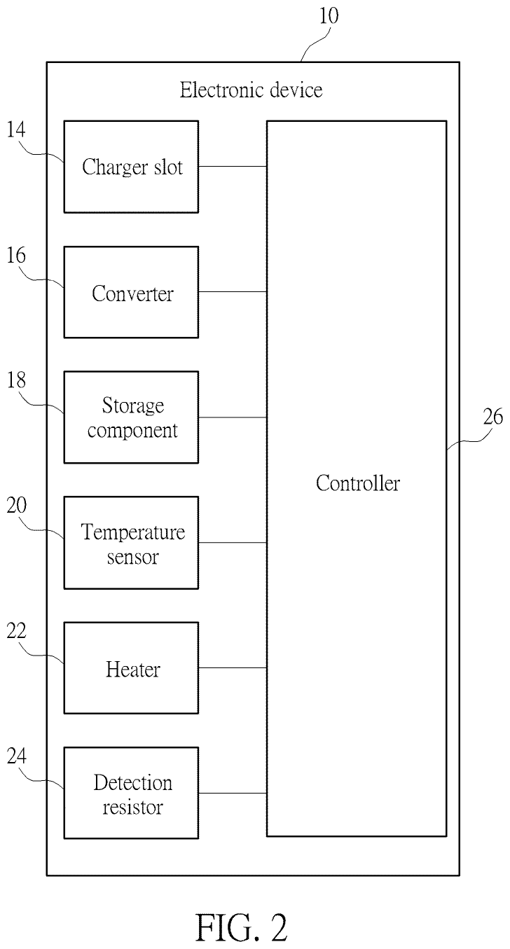

Please refer to FIG. 1 and FIG. 2. FIG. 1 is an appearance diagram of an electronic device 10 according to an embodiment of the present invention. FIG. 2 is a functional block diagram of the electronic device 10 according to the embodiment of the present invention. The electronic device 10 can be a multiple channel charger with a power control function, and can charge a plurality of external batteries 12 in turns or simultaneously; besides, the electronic device 10 can be a storage apparatus of the external battery 12, and the external battery 12 can be placed in the electronic device 10 without taking out after the external battery 12 is fully charged, so that the electronic device 10 can use the power control function to apply environmental control for stored power and storage temperature, and therefore the external battery 12 can provide preferred performance. A number and position on the electronic device 10 of the external battery 12 are not limited to the embodiment shown in the figures, and a detailed description is omitted herein for simplicity.

The electronic device 10 can at least include a charger slot 14, a converter 16, a storage component 18, a temperature sensor 20, a heater 22, a detection resistor 24 and a controller 26. The charger slot 14 can be electrically connected with the external battery 12, and electric energy can be transferred between the electronic device 10 and the external battery 12. A number of the charger slot 14 can be set in accordance with a design demand of the electronic device 10. The converter 16 can convert alternating current (AC) into direct current (DC), and can provide the electric energy to the external battery 12 through the charger slot 14. The storage component 18 can be a built-in battery of the electronic device 10 used to supply the electric energy for the external battery 12, or to receive the electric energy transferred from the external battery 12 or the converter 16. That is to say, when the electronic device 10 is not connected to the external power supply, the electric energy can be transferred from the storage component 18 to the external battery 12 for execution of a charger procedure; further, the external battery 12 can transfer the electric energy to the storage component 18 for storage when the external battery 12 is discharged.

The temperature sensor 20 can be used to detect an ambient temperature of an area where on the electronic device 10 is located. Discharge performance of the external battery 12 and/or the storage component 18 may be decreased when the electronic device 10 is in a low temperature environment, and the electronic device 10 can analyze the ambient temperature acquired by the temperature sensor 20 to apply the environmental control for the stored power and the storage temperature. The heater 22 can be used to adjust temperature of the storage component 18 and/or the external battery 12, so as to ensure the electronic device 10 has preferred charging and discharging performance. The detection resistor 24 can be disposed on a charging and discharging path of the electronic device 10; the electronic device 10 can convert a voltage value on the detection resistor 24 into a related current value during the charging and discharging process, so as to accurately control charging capacity or discharging capacity of the storage component 18 and/or the external battery 12. The controller 26 can be electrically connected with the charger slot 14, the converter 16, the storage component 18, the temperature sensor 20, the heater 22 and the detection resistor 24, and used to execute a power control method of the present invention.

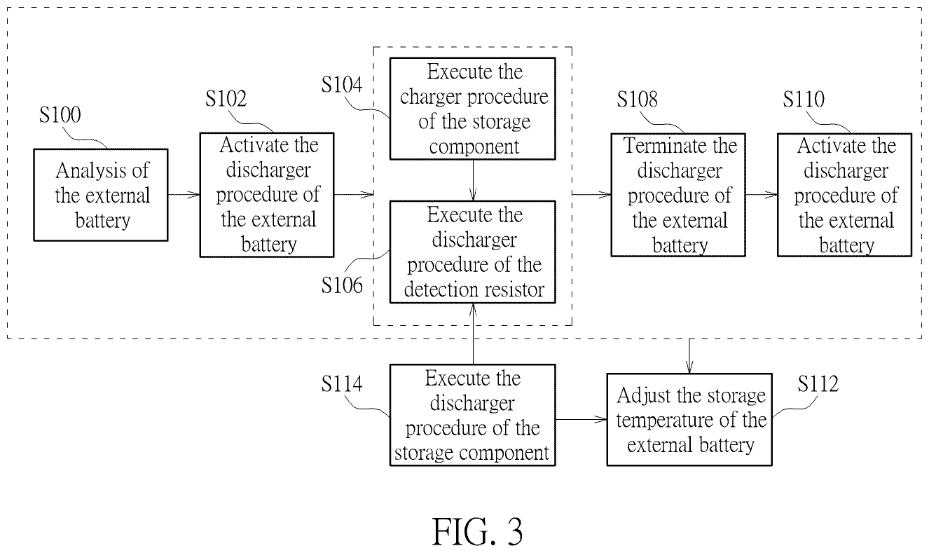

Please refer to FIG. 3. FIG. 3 is a flow chart of the power control method according to the embodiment of the present invention. The power control method illustrated in FIG. 3 can be suitable for the electronic device 10 shown in FIG. 1 and FIG. 2. Regarding the power control method, step S100 can be analysis of the external battery 12, and step S102 can be a discharger procedure of the external battery 12. In step S100 and step S102, the controller 26 can analyze and identify storage capacity and a previous usage point of time of the external battery 12 via the charger slot 14, and a clock (which is not shown in the figures) can be used to acquire a current point of time of the electronic device 10. If a period length between the previous usage point of time and the current point of time of the external battery 12 does not conform to a first predefined time condition (for example, time difference between the previous usage point of time and the current point of time is less than five to seven days), the external battery 12 is not idle, and the discharger procedure of the external battery 12 cannot be executed. If the period length between the previous usage point of time and the current point of time of the external battery 12 conforms to the first predefined time condition, the external battery 12 has been idle for too long, and the controller 26 can apply the discharger procedure for the external battery 12 to decrease the storage capacity. In the embodiment, the first predefined time condition can be five to seven days under better conditions; practical application of the first predefined time condition is not limited to the foresaid embodiment, and can be set in accordance with the electronic control equipment used in the electronic device 10 and the external battery 12.

Step S104 can be the charger procedure of the storage component 18, and step S106 can be the discharger procedure of the detection resistor 24. When the discharger procedure of the external battery 12 (in step S102) is executed, the controller 26 can optionally apply the charger procedure for the storage component 18 by using the discharger procedure of the external battery 12 in step S104, or can utilize the detection resistor 24 to directly release the stored electric energy of the external battery 12. However, regardless of whether the controller 26 executes the discharger procedure of the external battery 12 in step S104 or step S106, the controller 26 can execute step S108 to terminate the discharger procedure of the external battery 12 when the storage capacity of the external battery 12 conforms to the first predefined capacity condition. In the embodiment, the first predefined capacity condition in step S108 can be fifty percent of the total storage capacity, and have a purpose of reducing the storage capacity of the external battery 12 and avoiding the external battery 12 from excessive discharge simultaneously, so as to provide preferred battery storage. A value of the first predefined capacity condition is not limited to the foresaid embodiment, and can be varied in accordance with a battery property of the external battery 12.

Step S104 can utilize the discharger procedure of the external battery 12 to apply the charger procedure for the storage component 18, but remaining power of the external battery 12 may be greater than the total storage capacity of the storage component 18; if the storage component 18 has full power by the charger procedure in step S104, the power control method of the present invention can automatically or manually execute step S106 of utilizing the detection resistor 24 to apply the discharger procedure for the external battery 12.

Although step S108 may terminate the discharger procedure of the external battery 12, the external battery may be inevitably self-discharged due to electrochemical reactions; in order to avoid the external battery 12 from the excessive discharge for the preferred battery storage, step S110 can decide whether to activate the charger procedure of the external battery 12. For example, when the controller 26 determines that the storage capacity of the external battery 12 conforms to the second predefined capacity condition, the charger procedure can be applied for the external battery 12. Generally, the second predefined capacity condition can be forty percent of the total storage capacity, and a value of the second predefined capacity condition is not limited to the foresaid embodiment. In step S110, the controller 26 can preferably utilize the storage component 18 to execute the charger procedure of the external battery 12, and further can utilize the converter 16 to convert alternating current (AC) into direct current (DC) to apply for the charger procedure of the external battery 12. The charging source of the external battery 12 is not limited to the foresaid embodiment, and depends on the design demand.

In addition, if the plurality of external batteries 12 is respectively inserted into corresponding charger slots 14 of the electronic device 10, the power control method can analyze the storage capacity of each of the plurality of external batteries 12, and the power control method can first decide whether the charger procedure or the discharger procedure is applied for the external battery 12 with highest storage capacity among the plurality of external batteries 12. When the charger procedure or the discharger procedure of the external battery 12 with the highest storage capacity is finished, the power control method can sequentially decide whether the charger procedure or the discharger procedure is applied for the external battery 12 with second highest storage capacity among the plurality of external batteries 12. However, the electronic device 10 may further dispose activation switches (which are not shown in the figures) on the charger slots 14, and the user can utilize the activation switches to activate the corresponding charger slot 14 in accordance with an actual demand, so as to decide whether to apply the charger procedure or the discharger procedure for the external battery 12 inserted into the specific charger slot 14.

In the foresaid charger procedure and the discharger procedure, the power control method of the present invention can simultaneously decide whether to adjust the storage temperature of the external battery 12 by step S112. For example, the controller 26 can utilize the temperature sensor 20 to acquire the ambient temperature of the area where on the electronic device 10 and the external battery 12 are located, and then compare the ambient temperature with a predefined temperature condition. In the embodiment, the predefined temperature condition can be set as five degrees Celsius, and an actual value of the predefined temperature condition is not limited to the foresaid embodiment. If the ambient temperature is higher than five degrees Celsius, it means that the ambient temperature does not conform to the predefined temperature condition, and a current output and input function of the external battery 12 cannot be affected by the ambient temperature, so that the heater 22 is not activated. If the ambient temperature is lower than or equal to five degrees Celsius, it means that the ambient temperature conforms to the predefined temperature condition, and the current output and input function of the external battery 12 can be affected by the low temperature environment, so that the heater 22 can be activated to increase the temperature of the external battery 12.

In step S112, the controller 26 can utilize the converter 16 or the storage component 18 to provide the electric energy for activation of the heater 22. Besides, the power control method of the present invention can execute step S112 to adjust the storage temperature of the external battery 12 at any time in all stages from step S100 to step S110; further, the power control method may execute step S112 to decide whether the ambient temperature is low and the storage temperature of the external battery 12 needs to be increased when one or some of step S100 to step S110 are detected to be inefficient.

Moreover, the power control method of the present invention can optionally execute step S114 to decide whether the discharger procedure of the storage component 18 is executed. In the present invention, the electronic device 10 can have a function of self-discharging the storage component 18. When the storage component 18 does not provide the electric energy to the external battery 12 for execution of the charger procedure, and a continuous period of the ambient temperature acquired by the temperature sensor 20 not conforming to the predefined temperature condition (such as being higher than five degrees Celsius) conforms to the second predefined time condition, the power control method can apply the discharger procedure for the storage component 18, and can terminate the discharger procedure until the storage capacity of the storage component 18 reaches fifty percent of the total storage capacity. In the embodiment, the second predefined time condition can be set as fifteen days, and a value of the second predefined time condition can depend on the charging and discharging property of the storage component 18. A condition of terminating the discharger procedure can be set as the storage capacity of the storage component 18 reaching the first predefined capacity condition in step S108; practical application of the condition of terminating the discharger procedure is not limited to the foresaid embodiment. The power control method of the present invention can utilize the detection resistor 24 to execute the discharger procedure of the storage component 18 in step S114, and may further execute the discharger procedure of the storage component 18 in step S112 for driving the heater 22 to adjust the storage temperature of the external battery 12.

It should be mentioned that the functional blocks mentioned by the power control method of the present invention is not limited to an order shown in FIG. 3. The controller of the electronic device can detect the storage capacity and the previous usage point of time of the external battery, or detect whether the period length between the previous usage point of time and the current point of time conforms to the first predefined time condition, or detect whether the storage capacity conforms to the first predefined capacity condition or the second predefined capacity condition, or detect whether the ambient temperature acquired by the temperature sensor conforms to the predefined temperature condition, or detect whether the continuous period of the external battery not executing the charger procedure conforms to the second predefined time condition at any time, so the power control method can execute the charger procedure, the discharger procedure, and/or a heating procedure immediately in accordance with the detection result.

In conclusion, the electronic device of the present invention can be the multiple channel charger, and can be preferably applied for a drone device; therefore, when an emergency flight mission occurs, the electronic device and the power control method of the present invention can give priority to apply the charger procedure for the external battery with the highest storage capacity, and then apply the charger procedure for the external battery with the lower storage capacity, and finally apply the charger procedure for the storage component of the electronic device, so that the external battery can be quickly charged for being installed on the drone device to execute the emergency flight mission. In addition, the electronic device of the present invention can utilize the power control method to switch the charger procedure and the discharger procedure of the external battery and the storage component when the electronic device is idle for a long time, so as to constrain the storage capacity within a predefine range of the capacity condition, and further to adjust the temperature of the electronic device and the external battery via the temperature sensor and the heater, for increasing a product service life and providing the preferred operation performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power control method applied to an electronic device having a controller and at least one charger slot, the at least one charger slot being electrically connected with an external battery, the power control method comprising:
the controller analyzing storage capacity and a previous usage point of time of the external battery through the at least one charger slot, and
the controller applying a discharger procedure for the external battery to reduce the storage capacity when determining a period length between the previous usage point of time and a current point of time conforms to a first predefined time condition.

2. The power control method of claim 1, further comprising:
the controller terminating the discharger procedure when determining the storage capacity conforms to a first predefined capacity condition.

3. The power control method of claim 1, wherein the electronic device further has a storage component, the power control method further comprises:
the controller utilizing the discharger procedure of the external battery to apply a charger procedure for the storage component.

4. The power control method of claim 3, further comprising:
the controller utilizing the storage component to apply the charger procedure for the external battery when determining the storage capacity conforms to a second predefined capacity condition.

5. The power control method of claim 3, further comprising:
the controller utilizing a detection resistor to apply the discharger procedure for the external battery when the storage component has full power.

6. The power control method of claim 3, wherein the electronic device further has a temperature sensor and a heater, the power control method further comprises:
the controller driving the heater to increase a temperature of the external battery when an ambient temperature acquired by the temperature sensor conforms to a predefined temperature condition.

7. The power control method of claim 6, further comprising:
the controller utilizing the storage component to drive the heater.

8. The power control method of claim 6, further comprising:
the controller applying the discharger procedure for the storage component when the ambient temperature does not conform to the predefined temperature condition and a continuous period of the external battery not executing the charger procedure conforms to a second predefined time condition.

9. The power control method of claim 8, further comprising:
the controller utilizing a detection resistor to apply the discharger procedure for the storage component, or utilizing the discharger procedure to drive the heater.

10. The power control method of claim 1, wherein the electronic device further has a storage component and a plurality of external batteries, the power control method further comprises:
the controller utilizing the storage component to apply a charger procedure for one external battery with highest storage capacity among the plurality of external batteries, and then apply the charger procedure for other external batteries among the plurality of external batteries.

11. An electronic device with a power control function, the electronic device comprising:
at least one charger slot adapted to electrically connect with an external battery; and
a controller communicated with the at least one charger slot, the controller being adapted to analyze storage capacity and a previous usage point of time of the external battery through the at least one charger slot, and apply a discharger procedure for the external battery to reduce the storage capacity when determining a period length between the previous usage point of time and a current point of time conforms to a first predefined time condition.

12. The electronic device of claim 11, wherein the controller is adapted to further terminate the discharger procedure when determining the storage capacity conforms to a first predefined capacity condition.

13. The electronic device of claim 11, wherein the electronic device further comprises a storage component, the controller is adapted to further utilize the discharger procedure of the external battery to apply a charger procedure for the storage component.

14. The electronic device of claim 13, wherein the controller is adapted to further utilize the storage component to apply the charger procedure for the external battery when determining the storage capacity conforms to a second predefined capacity condition.

15. The electronic device of claim 13, wherein the controller is adapted to further utilize a detection resistor to apply the discharger procedure for the external battery when the storage component has full power.

16. The electronic device of claim 13, wherein the electronic device further comprises a temperature sensor and a heater, the controller is adapted to further drive the heater to increase a temperature of the external battery when an ambient temperature acquired by the temperature sensor conforms to a predefined temperature condition.

17. The electronic device of claim 16, wherein the controller is adapted to further utilize the storage component to drive the heater.

18. The electronic device of claim 16, wherein the controller is adapted to further apply the discharger procedure for the storage component when the ambient temperature does not conform to the predefined temperature condition and a continuous period of the external battery not executing the charger procedure conforms to a second predefined time condition.

19. The electronic device of claim 18, wherein the controller is adapted to further utilize a detection resistor to apply the discharger procedure for the storage component, or utilize the discharger procedure to drive the heater.

20. The electronic device of claim 11, wherein the electronic device further comprises a storage component and a plurality of external batteries, the controller is adapted to further utilize the storage component to apply a charger procedure for one external battery with highest storage capacity among the plurality of external batteries, and then apply the charger procedure for other external batteries among the plurality of external batteries.
